(19) United States
(12) Patent Application Publication
(10) Pub. No.: US 2022/0192101 A1
(43) Pub. Date: Jun. 23, 2022

(54) Plant Growth Promotion Device Based on a Multi-Layered Distributed System

(71) Applicant: Bright Solutions Ltd., Las Vegas, NV (US)

(72) Inventor: Haiwei WANG, Shanghai (CN)

(73) Assignee: Bright Solutions Ltd., Las Vegas, NV (US)

(21) Appl. No.: 17/156,377

(22) Filed: Jan. 22, 2021

(30) Foreign Application Priority Data
Dec. 17, 2020 (CN) 202023082948.6

(51) Int. Cl. A01G 7/04; A01G 9/24

(52) U.S. Cl. CPC A01G 7/045; A01G 9/246

(57) ABSTRACT

The present utility mode provides a plant growth promotion device based on a multi-layered distributed system. The plant growth promotion device based on the multi-layered distributed system includes LED lights and supporting members that each extends along the direction in which plants are planted, multiple LED lights being placed at different heights towards the lower side of the supporting members and being supported by the supporting members, and the LED lights being placed along the direction in which the supporting members extend. The present utility model has the beneficial effects of low cost and high growth promotion efficiency.

### CROSS-REFERENCE TO RELATED APPLICATIONS

This application claims priority to Chinese Patent Application No. 202023082948.6, filed on Dec. 17, 2020, the content of which is hereby incorporated by reference in its entirety.

### TECHNICAL FIELD

The utility model relates to plant growth, in particular to a plant growth promotion device based on a multi-layered distributed system.

### BACKGROUND OF THE INVENTION

Since, as commonly known, the growth of plants depends on photosynthesis. In winters, rainy days, nights or other times when there is not enough sunlight, indoor plants and flowers are less likely to photosynthesize effectively and may therefore suffer poor growth rate.

To solve these identified technical challenges, traditionally installed are fluorescent lamps which can promote plant growth to a certain extent and lengthen the blooming period, thus improving the quality of flowers and raising fruiting rate. However, this solution has the following problems:

1. Since ordinary fluorescent lamps emit full-spectrum lights, and lights with different wavelengths impact differently on plant photosynthesis, where blue lights (430-440 nm) and red lights (620-660 nm) contribute most to plant photosynthesis, while most of the lights emitted by traditional lamps are wasted, which is not energy-efficient nor environmentally friendly.

2. To improve the lighting effects, heavier lamps of more than 5 kilograms each are utilized, thereby imposing higher requirements for supporting members and causing the supporting members more prone to fractures and cause safety events.

3. With lamps being placed above plants, the lights emitted can only reach top leaves but not the leaves at different heights and therefore, have limited effects on promoting plant growth.

### SUMMARY OF THE INVENTION

To overcome the deficiencies in the current technologies, the present utility model provides a plant growth promotion device based on a multi-layered distributed system.

The objectives of the present utility model are realized through the following technical solutions:

A plant growth promotion device based on a multi-layered distributed system includes LED lights and further includes:

Supporting members that each extends along the direction in which plants are planted;

Multiple LED lights are placed at different heights towards the lower side of the supporting members and are supported by the supporting members, and the LED lights placed along the directions in which the supporting members extend.

Compared with the current technologies, the present utility model has advantages of:

1. Low cost;

The filaments of LED lights used can significantly reduce the cost of the plant growth promotion device and enhance lighting effects;

2. High growth promotion efficiency;

The LED lights used are mounted along the directions in which plants are planted and at different heights, thus significantly enhancing the lighting effects on the leaves of the plants at different heights and greatly promoting plant growth;

The filaments of LED lights used can emit blue and red lights that are needed for plant growth, which are adjusted as appropriate to maximize lighting effects and achieve energy-saving and environmentally friendly;

The LED lights are mounted at different heights between adjacent plants, which further improves the lighting effects on the plants on both sides of the lights;

3. Good safety;

The filaments of LED lights used are light in weight, which lowers the requirements for supporting members and correspondingly improves the safety.

### BRIEF DESCRIPTION OF THE DRAWINGS

With reference to the accompanying drawings, the disclosure of the present utility model can be understood more clearly. It can be clearly understood by those skilled in the art that these drawings are only provided to illustrate the technical solutions of the present utility model, and are not intended to limit the scope of protection of the present utility model. Among these drawings:

FIG. 1 illustrates a top view of the plant growth promotion device based on a multi-layered distributed system in accordance with embodiments of the present utility model;

FIG. 2 illustrates a schematic view of a single supporting member and an LED light in accordance with embodiments of the present utility model.

### DESCRIPTION OF THE EMBODIMENTS

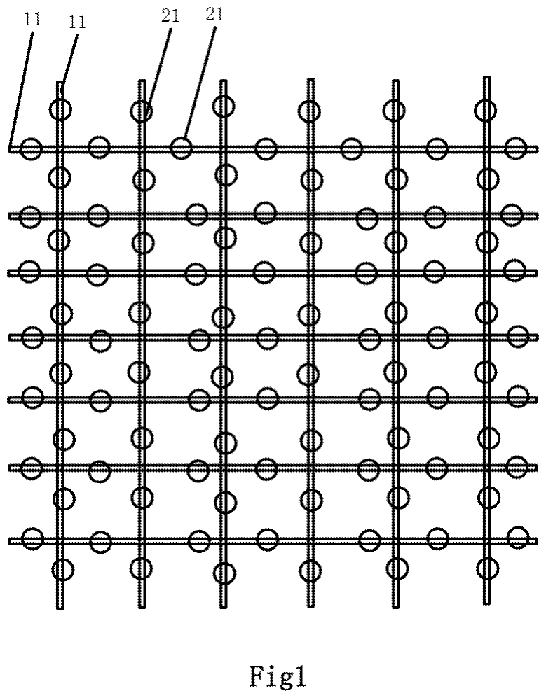

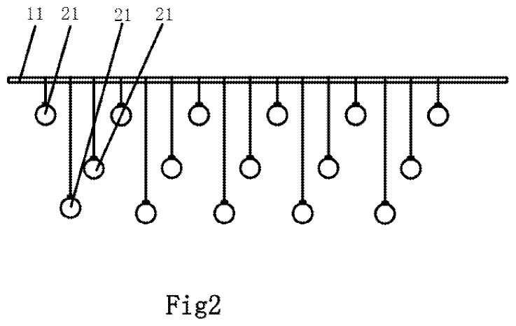

FIGS. 1-2 and the description below describe different embodiments of the present utility model to enable those skilled in the art to learn how to exploit and reproduce the present utility model. In order to elaborate the technical solutions involved in the present utility model, some general instructions are simplified or omitted. Those skilled in the art should understand that all variations or substitutes derived from these embodiments that fall within the scope of the present utility model, and that the following characteristics can be combined in every way to form multiple variations of the present utility model. Therefore, the present utility model is not limited to the following different embodiments, but is only limited by the claims and the equivalents thereof.

### Embodiment 1

FIG. 1 and FIG. 2 are schematic views showing the plant growth promotion device based on a multi-layered distributed system as described in embodiments of the present utility model. As shown in FIG. 1 and FIG. 2, the plant growth promotion device based on a multi-layered distributed system includes:

Supporting members 11 such as metal wires with certain rigidity, with multiple supporting members 11 extending along the directions in which plants are planted;

Multiple LED lights 21 that are placed at different heights towards the lower side of the supporting members 11 and supported by the supporting members 11, and are placed along the directions in which the supporting members 11 extend.

To improve lighting effects, multiple supporting components are distributed vertically and horizontally crosswise, and LED lights are located at different heights between adjacent plants.

To reduce weight and cost of an LED light, the LED light includes a bulb shell, a light-emitting unit and an electric coupler. The bulb shell and the electric coupler form a closed space; the light-emitting unit is situated in the closed space and is electrically connected to the electric coupler through wires; and the closed space is filled with a mixture of an inert gas and oxygen or with hydrogen and helium at a safe content amount.

To reduce weight of LED lights, the light-emitting unit includes LED chips and substrates, with multiple LED chips being electrically interconnected with each other, placed on the substrates and covered by a luminescent powder coating.

To emit lights in all directions to improve the lighting effects on plant leaves, the luminescent powder coating fully wraps and/or covers a mounting surface of the substrates, with the other side of the substrates that is opposite to the mounting surface of the LED chips being left uncovered.

To improve the lighting efficiency, the LED chips output red light and/or blue light.

### Embodiment 2

This embodiment describes an application case of the plant growth promotion device based on a multi-layered distributed system as described in Embodiment 1 of the present utility model.

In this application case, as shown in FIG. 1 and FIG. 2, supporting members 11 are rigid metal wires, such as iron wires, and are placed between adjacent rows and adjacent columns of plants, and multiple supporting members 11 extend along the directions in which plants are planted or, in other words, are placed vertically and horizontally crosswise in the row and column directions; if long supporting members 11 are needed, support rods can be used to hold supporting members;

LED lights 21 are placed at different heights towards the lower side of supporting members 11 and supported by supporting members 11; LED lights 21 are placed along the directions in which the supporting members 11 extend, forming a multi-layered distributed system;

An LED light includes a bulb shell, a light-emitting unit and an electric coupler, with the bulb shell and the electric coupler forming a closed space, and the light-emitting unit being arranged in the closed space and electrically connected to the electric coupler through wires; the closed space is filled with a mixture of an inert gas and oxygen or with hydrogen and helium at a safe content amount; the light-emitting unit includes LED chips (only chips outputting blue and red lights) and substrates, with multiple LED chips being electrically interconnected with each other serially or in parallel and being placed on the substrates, and with a luminescent powder coating covering the LED chips and fully wrapping the substrates to enable the light-emitting unit to emit lights in all directions;

The chips outputting blue and red lights are controlled in the following way:

Grouping control is applied, which involves several LED driving circuit branches corresponding to the LED lights as well as a light color switch connected to LED driving circuit branches. In this way, the light color switch is used to control the LED chips with different light colors to start individually, in groups, or simultaneously. The light color switch may include a light color switching control circuit and a power switch. By repeatedly turning on and off the power switch to output pulse signals to the light color switching control circuit, the LED driving circuit branches preset in different groups are switched to light up LED chips with different colors to achieve the switch among different spectrums. Besides, spectrums can also be switched and adjusted through Bluetooth communication, infrared remote control, WIFI communication, mobile APP and other means.

### Embodiment 3

This embodiment describes an application case of the plant growth promotion device based on a multi-layered distributed system as described in Embodiment 1 of the present utility model. Unlike Embodiment 2:

The luminescent powder coating covers the substrates, with only the other side of the substrates that is opposite to the mounting surface of the LED chips being left exposed.

What is claimed is:

1. A plant growth promotion device based on a multi-layer-ed distributed system, comprising:
LED lights; and
supporting members that each extends along a direction in which plants are planted,
wherein a plurality LED lights are placed at different heights towards a lower side of the supporting members and are supported by the supporting members, and the LED lights are placed along directions in which the supporting members extend.

2. The plant growth promotion device according to claim 1 is further characterized in that the multiple supporting members are distributed vertically and horizontally crosswise, and that the LED lights are located at different heights between adjacent plants.

3. The plant growth promotion device according to claim 1 is characterized in that the LED lights each comprises a bulb shell, a light-emitting unit and an electric coupler, wherein the bulb shell and the electric coupler form a closed space, the light-emitting unit is situated in the closed space and is electrically connected to the electric coupler through wires, and the closed space is filled with a mixture of an inert gas and oxygen or with a safe amount of hydrogen and helium.

4. The plant growth promotion device according to claim 3 is characterized in that the light-emitting unit comprises LED chips and substrates, wherein a plurality of LED chips are electrically interconnected with each other, arranged on the substrates, and covered by a luminescent powder coating.

5. The plant growth promotion device according to claim 4 is characterized in that the luminescent powder coating fully wraps or covers a mounting surface of the substrates, wherein the other side of the substrates that is opposite to the mounting surface of the LED chips is left uncovered.

6. The plant growth promotion device according to claim 3 is characterized in that the LED chips emit red light and/or blue light.
